(19) United States
(12) Patent Application Publication
(10) Pub. No.: US 2007/0108108 A1
(43) Pub. Date: May 17, 2007

(54) Paper materials sorting apparatus

(75) Inventor: Takeshi Aoki, Kanagawa-ken (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/476,734

(22) Filed: Jun. 29, 2006

(30) Foreign Application Priority Data
Jun. 29, 2005 (JP) P2005-190682

(51) Int. Cl. B07C 5/00

(52) U.S. Cl. 209/534

(57) ABSTRACT

A paper materials sorting apparatus characterized by preparation, having a note denomination discriminating means for taking out paper material from a feeder supplied collectively, and for discriminating the note denomination of the paper materials, and a sorting means for sorting the paper materials for every note denomination based on a result of discrimination by the note denomination discriminating means, and to perform discrimination processing of wrapping or storing, a cassette assignment means for assigning a note denomination to be sorted by the sorting means to the wrapping means or the storage, the sorting means, comprising a counting means which carries out counting of the throughput of the paper materials by which sorting operation is performed with each sorting means based on the cassette assignment means, a comparison means to measure a throughput between the sorting means based on a result of counting by the counting means, a comparison result display means which displays a comparison result by the comparison means, and an operation display means which performs an operation indication by the cassette assignment means, and a comparison result indication by the comparison result display means.

### CROSS-REFERENCE TO RELATED APPLICATION

This application is based upon and claims the benefit of priority from prior Japanese Patent Application No. 2005-190682 filed on Jun. 29, 2005; the entire contents of which are incorporated herein by reference.

### BACKGROUND OF THE INVENTION

1. Field of the Invention

This invention relates to a paper materials sorting apparatus which has a sorting device which sorts paper materials, such as valuable papers by appropriately discriminating them. Further, the present invention relates to a paper materials sorting apparatus which is able to choose an appropriate storage cassette according to the throughput of every discrimination of paper materials.

2. Description of the Related Art

As shown in the Japanese patent No. 2798979, conventional paper materials sorting apparatus for sorting paper materials such as valuable papers conveys paper materials by taken out one by one hopefully at a constant interval. The paper materials are conveyed to a note denomination discriminating device. The note denomination discriminating device discriminates the class (hereinafter referred to as note denomination) of the paper materials concerned, postures of the paper materials, authenticity of the paper materials concerned, and the authenticity (authentic note or counterfeit note) of the paper materials concerned, and the re-circulation conformity (re-circulation possible or impossible) of the paper materials concerned. The conventional paper materials sorting apparatus had discriminated from paper materials based on these discrimination results, and had distributed it to the processor which comprises respectively suitable numbers, such as a paper materials paper-strip wrapping device or a storage device. At the time, notes to be wrapped with each paper-strip wrapping device, and notes to be merely stored in each storage cassette are assigned by key-input according to operator to the operation display which controls a paper materials sorting apparatus, touch input to touch-panel on a display screen or mouse operation.

If the paper materials which was able to be distributed to the paper-strip wrapping device has an exception of re-circulation accurate and disqualification classified, and is stored if needed and predetermined number of sheets, for example, 100 sheets, is reached The set of 100 sheets are rounded and wrapped with the paper strip supplied from the paper strip reel carried in the device (see, for example, the above-mentioned Japanese patent No. 2798979). This bundled paper materials of 100 sheets is called a bundle.

However, with the paper materials sorting apparatus given in the Japanese patent No. 2798979, the storage cassette or the paper-strip wrapping device was uniquely assigned by the operator for every note denomination. Therefore, between the storage cassettes and paper-strip wrapping device which process a note denomination with much turn volume, and the storage cassette which processes a note denomination with little turn volume and a paper-strip wrapping device, operating ratio, i.e., a load, had a problem which imbalanced produces. Since an operator does not recognize the cumulative load concerning each processor, allotment of the note denomination was not able to be adjusted in consideration of the size of the load concerning the amount, i.e., the storage device, and paper-strip wrapping device of turn volume for every note denomination. As a result, the life difference arose between processors and paper materials sorting apparatus was not able to be employed efficiently.

### SUMMARY OF THE INVENTION

By having been made in order that the present invention might solve the above-mentioned problem, and enabling it to measure the cumulative load of each storage cassettes or a paper-strip wrapping device for every operation. The present invention aims to provide the paper materials sorting apparatus which can notify an operator of the information for performing suitable cassette assignment to each storage cassettes and paper-strip wrapping device in the case of the next operation.

According to the embodiments of the present invention, banknotes processing apparatus is provided with, note denomination discriminating means which the paper materials of a note denomination takes out one sheet at a time from the feeder supplied collectively at a fixed interval, conveys, and discriminates the paper materials, a multiple sorting means for sorting the paper materials for every note denomination based on the result of discrimination by the note denomination discriminating means, and to perform discrimination processing of wrapping or accumulation, a cassette assignment means which can be assigned by an operator about notes to be sorted by the sorting means. It is characterized by that the sorting means includes a counting means which carries out counting of the throughput of the paper materials by which sorting operation is performed with each sorting means based on the cassette assignment means, a comparison means to measure the throughput between the sorting means based on the result of counting by the counting means, a comparison result display means which displays the comparison result by the comparison means, and an operation display means which performs the operation indication by the cassette assignment means, and the comparison result indication by the comparison result display means,

### BRIEF DESCRIPTION OF THE DRAWINGS

FIG. 1 is a schematic diagram of the paper materials sorting apparatus by the first embodiment according to the present invention;

FIG. 2 is a block diagram showing the composition of a note denomination discriminating device and a main control portion;

FIG. 3 is a detailed view showing the horizontal conveyer line of a conveying portion and the conveying carrier which constitutes a paper-strip wrapping device;

FIG. 4 is a bar graph showing the throughput according to note denomination and conveying carrier operation frequency ratio per unit time;

FIG. 5 shows an operation screen according to the first embodiment of the present invention;

FIG. 6 shows an operation screen according to the second embodiment of the present invention;

FIG. 7 shows an operation screen according to the third embodiment of the present invention; and

FIG. 8 shows a bar graph with which the processed number of notes discriminated by note denomination, and a processed number-of-sheets operation ratio.

### DETAILED DESCRIPTION OF THE INVENTION

Hereafter, the embodiment of the present invention will be explained with reference to a drawing.

### First Embodiment

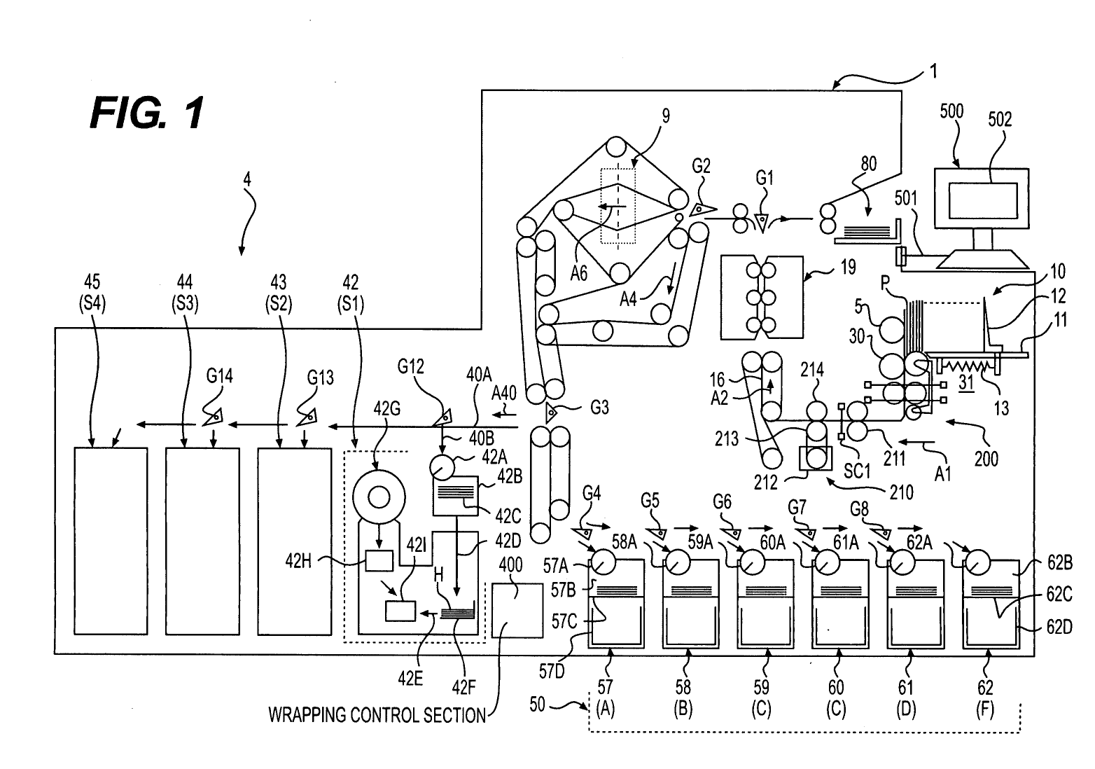

FIG. 1 is a schematic diagram of the paper materials sorting apparatus by the embodiment of the present invention. The paper materials sorting apparatus, is comprised of a mechanical portion 1 and a main controller 500. Through the operation of the operator to operation displays (it is also called as operation display means) 502, several operations, that is, setting up of working operations for inputting notes, organizing service, assignments of notes (hereinafter, referred to as cassette assignment) to the paper-strip wrapping devices 42-45, and storages 57-62, and setting of discriminating level of notes possible impossible to be re-circulated. After the assignments, one paper materials P of a multiple note denominations supplied to feeder 10 is taken out at a time, and is conveyed to note denomination discriminating device 19. In note denomination discriminating device 19, the note denomination of each paper material P is discriminated. It is conveyed to paper materials P from which the note denomination was discriminated with the note denomination discriminating device 19, specified paper-strip wrapping devices 42-45, or storages 57-62, and is stored by each cassette 57D-62D.

The amount of notes wrapped at the time of the termination of operation of note denomination discriminating device 19 and deadline processing of the amount of accumulation note denominations is merely performed. Balance processing which totals the number of dealings in-units, such as business finishing of an entire day, is performed.

A paper materials inputting operation is an operation for defining notes possible to be re-circulated and the other notes impossible to be re-circulated in every note denomination, every posture, and checks the amount of total money counted in the paper materials sorting apparatus 1 agreeing with the total amount of money before the sorting processing, and for registering them to the sorting apparatus 1. Paper materials P are wrapped at paper-strip wrapping devices 42-45, or is stored by each cassettes 57D-62D of storages 57-62.

Organizing service is a residual operation other than registering of counting into a system in payment operation. That is, the organizing service is operation for carrying out counting of the note denomination in which it traded accumulates, but the object is not to count payment operation etc. For example it is a service for storing for every posture of paper materials still in detail on each cassette 57D-62D of storages 57-62 or a paper-strip wrapping device.

Cassette assignment is specifying the note denomination which wraps with paper-strip wrapping devices 42-45, and the note denomination stored to each cassettes 57D-62D of storages 57-62.

For example, in the case of a receiving process, a note denomination with much turn volume is usually assigned to a paper-strip wrapping device, and performs paper-strip wrapping operation. When the paper-strip wrapping device is adjusted a total of note denomination several minutes, terminated by the above-mentioned processing. However, when there are seven kinds of note denominations, the paper-strip wrapping devices 42-45 assign to first four note denominations to which only four sets are connected in many cases to paper-strip wrapping devices 42-45, and assign the three remaining note denominations to cassettes 57D-59D of storage s 57-59. To the notes stored in the storage cassettes 57D-59D, changing assignment of paper-strip wrapping devices 42-45, and performing re-taking in, after paper-strip wrapping processing of top 4 note denominations is completed, paper-strip wrapping processing, carrying out (organizing service), the paper materials counter marketed performs the number of sheets check-back, and bundle bunch processing is performed manually. Hereafter, when the example also processes eight note denominations, it attaches and explains.

Re-circulation conformity discrimination threshold level setting is a setting of the threshold level discriminates notes possible to be re-circulated and notes impossible to be re-circulated. It will be described in detail later.

Deadline processing of dealings means operation for transferring notes in the storages 57-62 into the cassettes 57D-62D when completion operation touch panel 502 is operated. Each cassette in which paper materials was accommodated is exchanged with an empty cassette by the operator.

Here, postures in case paper materials P are conveyed are explained. There are four states in the posture of the paper materials P, i.e., a posture where the front-side is up (hereinafter, referred at as F-posture), a posture where the backside is up (hereinafter, referred to as B-posture, an erected posture (hereinafter, referred to as E-posture), an inverted posture (hereinafter, referred to as I-posture), i.e., an FE (front and erected) posture, an FI (front and back) posture, a BE (back and erected) posture and a BI (back and inverted) posture.

Mechanical portion 1 has feeder 10 which supplies paper materials P, paper materials extraction device 200 which takes out one paper materials P at a time from the feeder 10, and conveyer line 16 which conveys paper materials P taken out from the paper materials extraction device 200 in the arrow A1 direction. The conveying pitch of paper materials P which has the conveyer line 16 conveyed is amended by conveying pitch compensation portion 210. Note denomination discriminating device 19 which discriminates at a time one note denomination of paper materials P amended by the conveying pitch compensation portion 210 is located along conveyer line 16. In order to adjust the posture of paper material P among the four postures, specific posture, for example, the FE-posture, posture adjusting portion 9 is adjusted. Paper materials P adjusted with the specific posture in posture adjusting portion 9 is merely stored for every note denomination with storages 57-62 which are assigned for wrapping processing for every note denomination with paper-strip wrapping devices 42-45 assigned previously by operation display 502 according to those note denominations, or are similarly specified beforehand by operation display 502.

Mechanical portion 1 is connected to main controller 500 via interface 501. Hereafter, the composition of mechanical portion 1 will be explained sequentially from the feeder of paper materials P.

The above-mentioned feeder 10 comprises stage 11 which contacts and carries out ready grade of the paper materials P in which four kinds of postures are intermingled, and backup plate 12 assigned in the perpendicular direction to the stage 11. This backup plate 12 is movable on left-hand side along stage 11 according to the energizing force of spring 13. Thus, supplied paper materials P is pushed by pressure to the pickup roller 5 side with backup plate 12. In the state, when take-off roller 30 rotates, paper materials P has a constant interval, is taken out one sheet at a time, and it lets it out to conveyer line 16.

Conveying pitch compensation portion 210 is provided with timing sensor SC1 which conveying pitch compensation portion 210 is approached and installed in proximity of the conveying roller 211 at the downstream of the conveying direction, and detects paper materials P, conveyer roller 213 into which rotational speed can be changed with a driving force from a conveyer roller drive motor 212, and conveying pitch control portion (not shown) which controls pinch roller 214 and conveyer roller drive motor 212 by which the placed opposite was carried out to the conveyer roller 213.

Branching gate G1 is for example a gate for sorting rejected notes and notes to be processed. The rejected paper materials P are those discriminated in the discriminating device 19 as fake notes or note impossible to be re-circulated, counterfeit notes or note failed to be discriminated by being broken, skewed, etc. A conveyor controller's (for details, it mentions later) reception of the discriminated result will accumulate the rejected note concerned on rejection storage portion 80 by rotating branching gate G1 on right-hand side (clockwise rotation).

The processed note refers to the paper materials by which paper materials P discriminated by the note denomination discrimination portion of note denomination discriminating device 19 was discriminated from the right ticket with the true ticket, and it was discriminated from the disadvantage ticket with the true ticket. If the discriminated result is received, a conveyor controller (detailed in later) will rotate branching gate G1 on left-hand side (counterclockwise rotation), and will convey the paper materials concerned in the direction which carries out discrimination processing.

Branching gate G2 is a front/back reversing branching gate. Based on the posture of paper material P discriminated by the note denomination discrimination portion, the paper material P required to be reversed front/back is turned right (clockwise) and then reversed in front/back reversing portion 9 as indicated with arrow sign A6. When unnecessary to be reversed front/back, branching gate G2 is turned left and thus paper material P is forwarded in the direction as indicated by arrow sign A4.

Front/back reversing portion 9 reverses the front/back of paper materials P based on the result discriminated by the note denomination discrimination portion of note denomination discriminating device 19. For example, when a posture of paper material P is a BE (back erection) posture, it is reversed to the FF (front erection) posture by front/back reversing portion 9.

Branching gate G3 is a branching gate which branches paper materials P conveyed from conveyer line (main conveying passage) 16 to paper-strip wrapping devices 42-45 of paper strip wrapping portion 4, or storages 57-62 of storage portion 50. In the case of the note denomination specified that paper materials P conveyed is designated to be stored by main controller 500, a conveyor controller rotates branching gate G3 on left-hand side (counterclockwise rotation), and it distributes it so that paper materials P may be stored in storages 57-62 via gates G4-G8 from gate G3. In the case of the notes designated to be wrapped, a conveyor controller rotates branching gate G3 on right-hand side (clockwise rotation), and conveys paper materials P in the direction of paper-strip wrapping devices 42-45 shown by graphic display arrow A40.

In order to sort into paper-strip wrapping devices 42-45 and storages 57-62 from the conveyer line by which paper materials P are conveyed, the storage devices with bladed wheel is constituted as storage cassettes for storing paper materials P on the termination of a conveyer line.

For example, in the case of storage cassette 57, it comprises a bladed wheel 57A, a temporary storage cassette 57B, a shutter 57c and a bushing (not shown) which assists the storing operation.

The bladed wheel 57A has multiple blades mounted around the periphery of rotating shaft. And bladed wheel 57A rotates in synchronization with conveyance of paper materials P so that conveyed paper materials P can be received between blades. Absorbing the kinetic energy of paper materials P conveyed at high speed by using the bladed wheel 57A, where ready grade is carried out, the paper materials P concerned is stored in temporary storage cassette 57B.

Temporary storage device 57B used in the storage device 57 is equipped with shutter 57C, and paper materials P are stored on shutter 57C. And when the paper materials P are overfilled on the shutter 57C or operation termination is directed, shutter 57C opens and the paper materials P stored on shutter 57C fall down to cassette 57D below the shutter 57C and stored therein.

In this embodiment, paper strip wrapping portion 4 comprises four paper-strip wrapping devices 42-45, and arranged in order toward the downstream of the conveying direction. Since these four paper-strip wrapping devices 42-45 are similarly constituted by each, only paper-strip wrapping device 42 has shown the internal configuration to details.

Paper-strip wrapping device 42 comprises a bladed wheel 42A, temporary storage cassette 42B, backup plate 42C, a conveying portion, and a paper-strip wrapping portion.

Since temporary storage cassette 42B differs to temporary storage cassette 57B used in storage device 57 in relations to the processing object henceforth. That is, for example, if the amount of paper materials P stored on backup plate 42C reach to 100 sheets (hereinafter, referred to as 100-sheets paper materials lump H), a pusher (not shown) will descend and then the 100-sheets paper materials lump H will be stuffed into temporary storage cassette 42B of paper-strip wrapping device 42. Next, conveying carrier 42F which holds and mentions 100-sheets paper materials lump H later with backup plate 42C and the pusher is passed.

A conveying portion comprises longitudinal conveying path 42D, conveying carrier 42F, and horizontal conveyer line 42E. Longitudinal conveying path 42D is for elevating or pulling down the 100-sheets paper materials lump H received on backup plate 42C. Conveying carrier 42F receives 100-sheets paper materials lump H from backup plate 42C in the stop position of longitudinal conveying path 42D, and in order to pass a wrapping tray (not shown), it is constituted so that reciprocation moving of the horizontal conveyer line 42E top can be carried out.

A paper-strip wrapping portion is comprised of a paper strip 42G for a paper strip portion to wrap 100-sheets paper materials lump H loaded into the wrapping tray, a paper strip feeding portion 42H provided with a printing mechanism for printing the paper strip 42G and a feeding mechanism for feeding the paper strip 42G, a paper strip wrapping portion 421 for wrapping the 100-sheets paper materials lump H with the paper strip 42G fed from the paper strip feeding portion 42H and a paper strip wrapping controller 40 for controlling a paper-strip wrapping portion 4. Here, as mentioned above, wrapping devices 43-45 are constituted in similar to the above-mentioned paper-strip wrapping device 42.

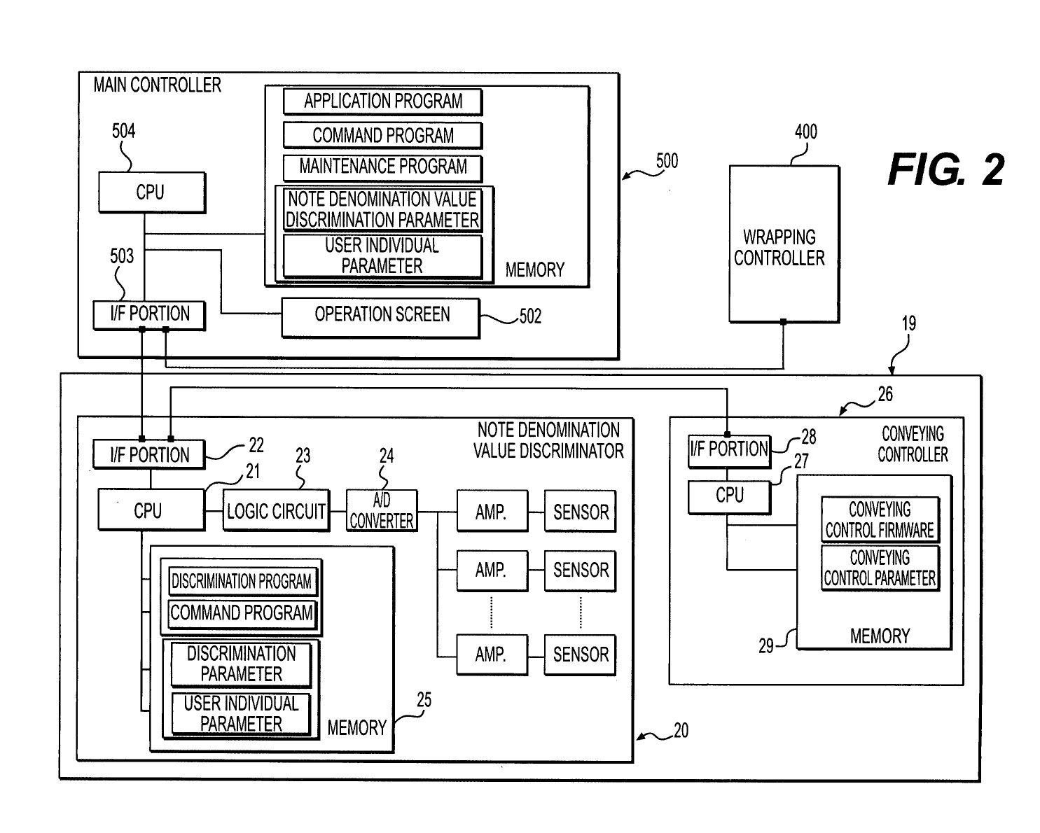

FIG. 2 is a block diagram showing the composition of note denomination discriminating device 19 and main controller 500. Ticket type discriminating device 19 comprises note denomination discriminator 20 which discriminates paper materials P, and conveyor controller 26 which determines the destination of paper materials P conveyed.

Ticket type discrimination portion 20 comprises a processing means to process the output signal of amplifying circuits AP1-APn which amplify the output signal of a multiple sensors S1-Sn for detecting the optical property and magnetic property in connection with construction material of paper materials P, and these sensors S1-Sn, and these amplifying circuits AP1-APn. This processing means has A/D converter 24 for carrying out A/D conversion, and logic circuit 23 which does the logical operation of the data by which A/D conversion was carried out in the A/D converter 24. This processing means has CPU 21 which controls note denomination discrimination, posture discrimination, authenticity (are they genuine article or imitation?) discrimination, re-circulation conformity discrimination, and the whole note denomination discriminator 20 from the output signal of the logic circuit 23. This processing means has I/F portion 22 for communicating the result and data which were discriminated by memory 25 which is accessed CPU 21 between main control portions 500, and is constituted by CPU 21 again.

Carrier control portion (control means) 26 determines the destination of paper materials P according to the discriminated result of note denomination discriminator 20, and comprises CPU27 which performs conveyance control of paper materials P, memory 29 accessed by the CPU27, and I/F portion 28 with note denomination discriminator 20.

Conveyance control of the paper materials P is carried out by conveyor controller 26 which controls by the above composition conveyance of paper materials P discriminated by note denomination discriminator 20, and wrapping controller 400 which wraps paper materials P conveyed by the conveyor controller 26.

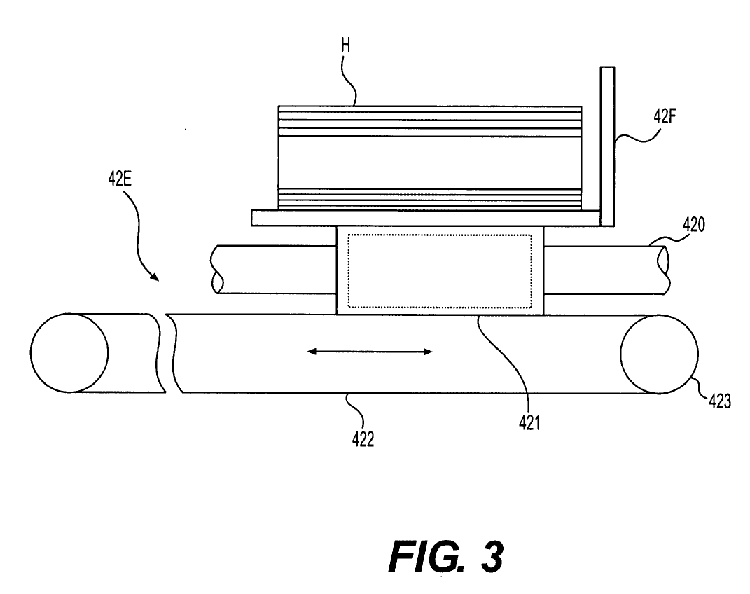

FIG. 3 is horizontal conveyer line 42E of a conveying portion and the detailed view of conveying carrier 42F which constitute paper-strip wrapping device 42, for example. Conveying carrier 42F is laid on linear bushing 421. Linear bush 421 fits into linear shaft 420 located in parallel with horizontal conveyer line 42E, and moves along with linear shaft 420. This conveying carrier 42F is being fixed to timing belt 422 by it and interlocking move good ability. Therefore, when timing belt 422 moves horizontal conveyer line 42E with a drive motor (not shown), conveying carrier 42F is guided by linear shaft 420 and moves. The above-mentioned linear bushing 421 absorbs the vibration when carrying out transverse movement by predetermined number of sheets, for example, the state where paper materials H of 100 sheets was loaded, has a percolating function.

In order to go and come back to linear bushing 421 one time for every strip-wrapping operation, in the case of the paper-strip wrapping device of a note denomination with many throughputs of paper materials, damage by friction of the above-mentioned sliding portion becomes large, and a life becomes short.

Usually, for example, like a note, when the paper materials of a multiple note denominations (variety amount of money) is published, there is a remarkable difference in the re-circulation ratio for every note denomination, and a big difference arises in the throughput which a paper materials sorting apparatus processes according to the ratio. Therefore, if a note denomination is fixed for every paper-strip wrapping device, lives differ according to each throughput.

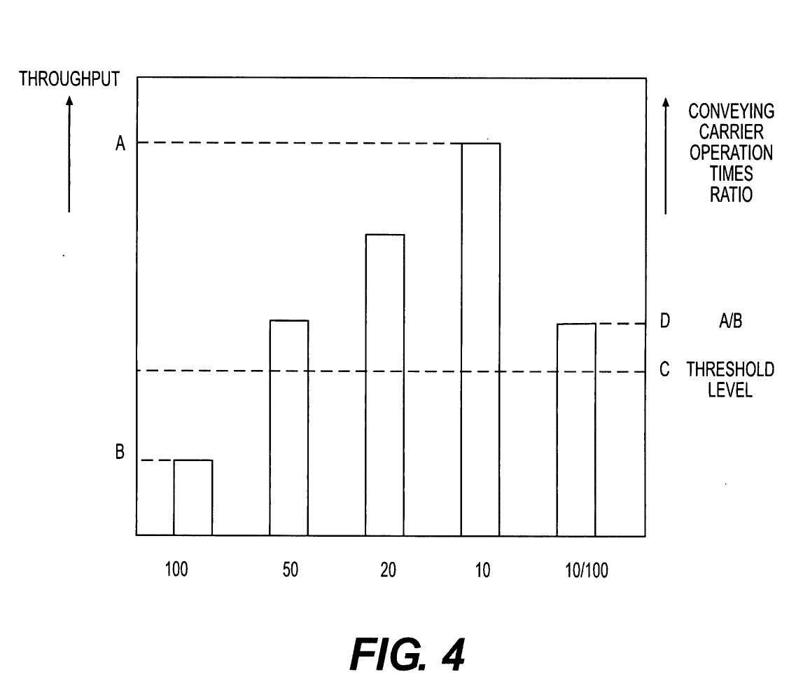

FIG. 4 shows the graph which shows the throughput according to note denomination and conveying carrier operation frequency ratio (namely, ratio of wrapping number of times) within-unit time. The vertical axis on the left of a graph indicates a throughput, and the horizontal axis indicates each note denomination. Further, the vertical axis on the right indicates a conveying carrier operation frequency ratio. Hereafter, with reference to the graph of FIG. 4, the leveling means of the mechanical load of a paper-strip wrapping device will be explained.

FIG. 4 shows an example for calculating a ratio of the least throughputs (processed amount) of notes and the largest throughputs (processed amount) of notes among four classes of note, e.g., 100-denomination notes, 50-denomination notes, 20-denomination notes, and 10-denomination notes. Here, throughput means the number of times which wrapped 100-sheets paper materials lump H and formed the bundle. Therefore, a throughput and a carrier operation frequency become the same value. By a diagram, the throughput of most note denominations of the throughput is A with 10-denomination notes, fewest note denominations of a throughput are 100-denomination notes, and the throughput has become B. Carrier operation frequency ratio D at that time is shown by the following Equation (1).
D=A/B (1)

Here,

A: The throughput of most 10-denomination notes of a throughput

B: The throughput of fewest 100-denomination notes of a throughput

Next, it compares with threshold level C which determines the right or wrong of exchange of conveying carrier operation frequency ratio D obtained by the Equation (1), as shown in following Equation (2).
D>C (2)

Since imbalance of the throughputs in dealings operation occurs when carrier operation frequency D exceeds the above-mentioned threshold level C, the recommendation cassette assignment to the next operation is displayed, and an operator is notified.

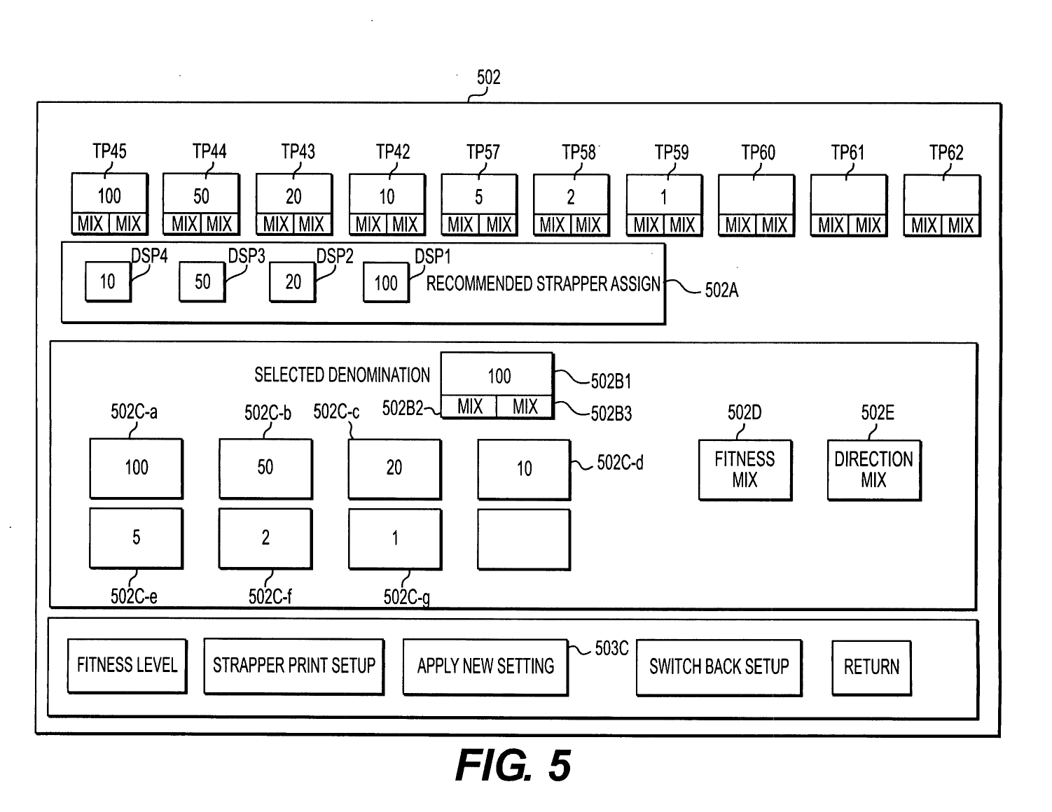

FIG. 5 shows the operation screen according to the first embodiment of the present invention, and is an example in the case of notifying an operator of recommendation cassette assignment based on conveying carrier operation frequency ratio D shown in FIG. 4. The example which notifies recommendation cassette assignment will be explained also referring to the paper materials sorting apparatus of FIG. 1. Corresponding to paper-strip wrapping devices (it is also called as wrapping means) 42-45, touch panels TP42-TP45 are formed in operation screen (operation display means) 502, and touch panels TP57-TP62 are formed in it corresponding to storage cassettes (they are also called as storage means) 57-62. Hereafter, when performing cassette assignment using each of these touch panels TP42-TP45, and TP57-TP62, it attaches and explains. Here, the discrimination of note denomination will be explained in assuming processing of 1-denomination notes, 2-denomination notes, 5-denomination notes, 10-denomination notes, 20-denomination notes, 50-denomination notes, and 100 denomination notes.

First, based on the cassette assignment means mentioned later, cassette assignment of paper-strip wrapping devices 42-45 and storages 57-62 is performed from operation screen 502. As one example, by assigning 100-denomination note to touch-panel TP42, 20-denomination note to touch-panel TP43, 50-denomination note to touch-panel TP44, and 100-denomination note to touch-panel TP45, here performed cassette assignments of paper-strip wrapping devices 42-45. Further, cassette assignments of storage s 57-59 are performed by assigning 5-denomination note as touch-panel TP57, 2-denomination note to touch-panel TP58, 1-denomination note to touch-panel TP59. Storage devices 60-62 are not note denomination specified. This example explains the case where an operator is notified with the application of recommendation cassette assignment at a paper-strip wrapping device.

Next, predetermined dealings operation is performed based on the above-mentioned cassette assignment. Next, balance processing which totals the number of dealings accompanying the dealings business finishing is performed.

In connection with the termination of the above-mentioned balance processing, when the trading volume of the paper-strip wrapping device per unit time, as shown in FIG. 4 is obtained, that is, when conveying carrier operation frequency ratio D given by Equation (1) fills a Equation (2), it turns out that the throughput of paper-strip wrapping device 42 which wraps 10-denomination notes is more than the throughput of paper-strip wrapping device 45 which wraps 100-denomination notes exceeding predetermined threshold level C, and unbalance has occurred.

In the case, main controller 500 displays the recommendation cassette assignment at the time of the next dealings on RSA (abbreviation for Recommended Strapper Assignment) of cassette assignment to paper-strip wrapping device or storage cassette is recommended by the indication area 502A of operation screen (it is also called as operation display means) 502. Another touch panel (it is also called as input means) is set to the operation screen 502, and it can input by touching various touch panels selectively. Although it is also possible to use the mouse connected to CPU504 of main controller 500 and a keyboard (not shown), the example explains the case where a touch panel is used as an input means to an example.

Here, to exchange assignments of paper-strip wrapping devices between 10-denomination notes with many throughputs, and 100-denomination notes with few throughputs, a cassette assignment of 100-denomination note is displayed on the display area DSP1 of the RSA display 502A, and displays the cassette assignment on the display area DSP4 to recommend the cassette assignment of the 10-denomination note. On the other hand, the note denomination of viewing-area DSP2 and viewing-area DSP3 displays the cassette assignment directions left intact.

Next, the cassette assignment resetting means of changing into 100-denomination notes 10-denomination notes currently displayed on viewing-area DSP1 will be explained.

First, 100-denomination note is assigned by touching note denomination setting touch-panel 502C-a. At the time, the numeric value “100” showing 100-denomination note is displayed on note denomination indication touch panel 502B.

The exception of re-circulation accurate and disqualification of the note denomination dealt with is displayed on re-circulation accurate and disqualified indication touch-panel 502B-2, and it is set to it with re-circulation accurate and disqualified indication change touch panel 502D. That is, whenever it touches the re-circulation accurate/un-accurate display switching touch panel 502D, note possible to be re-circulated number of sheets (Fit), re-circulation un-accurate ticket number of sheets (Unfit), and the mixture number of sheets (Mix) of a note possible to be re-circulated and a re-circulation un-accurate ticket are displayed on that screen in order.

Mixture number of sheets is displayed in the illustrated example.

The exception of a posture of paper material P is displayed on posture indication touch panel 502B3, and it is set to it with posture change touch panel 502E. That is, whenever it touches the posture change touch panel 502E, FE (front erection) posture, FI (front and inverted) posture, BE (back and erected) posture, BI (back and inverted) posture, and Mix (mixture of two or more of FF posture, FR-posture, BF-posture and BR-posture) are switched in order. The illustrated example shows the case where it is switched and set as Mix. The note denomination indication touch panel 502B1 and the touch-panel 502B-2 which display a note denomination, and the posture indication note possible to be re-circulated and re-circulation un-accurate indication touch panel 502B3 which assigned a posture are independently, respectively, and a paper-strip wrapping device and an storage cassette are able to be arbitrarily assigned. FIG. 5 shows the state.

Next, the note denomination set as the note denomination setting touch-panel 502C-a-502C-g is specified as a predetermined paper-strip wrapping device. In the case, e.g., 10-denomination notes is input by touching the input touch-panel TP42 (portion as which numerical “10” is displayed), for example. The content of note denomination indication touch panel 502B1, a note possible to be re-circulated and re-circulation un-accurate indication touch-panel 502B-2, and posture indication touch panel 502B3 is displayed on the field to which touch-panel TP42 corresponds, respectively as a result of the touch input. This 10-denomination note that does in the way and is set as touch-panel TP42 is changed into 100-denomination notes. Next, 100-denomination notes set as touch-panel TP45 in similar to the procedure in the case of changing into 100-denomination notes 10-denomination notes set as touch-panel TP42 mentioned above are changed into 10-denomination notes.

Next, if all the note denomination change is completed, cassette assignment execution touch panel (Apply New Setting) 503C will be touched, and cassette assignment will be performed. The note denomination specified as each device by the above operation can be changed.

As mentioned above, according to the first embodiment, an operator can be notified of the information for the cassette assignment in the next dealings (operation) by measuring the cumulative load of a paper-strip wrapping device. If an operator performs cassette assignment based on the information, leveling of the load of a processor is attained, and only a specific processor does not become a short life, therefore a maintenance service is frequently needed, and efficient employment can be aimed at.

### Second Embodiment

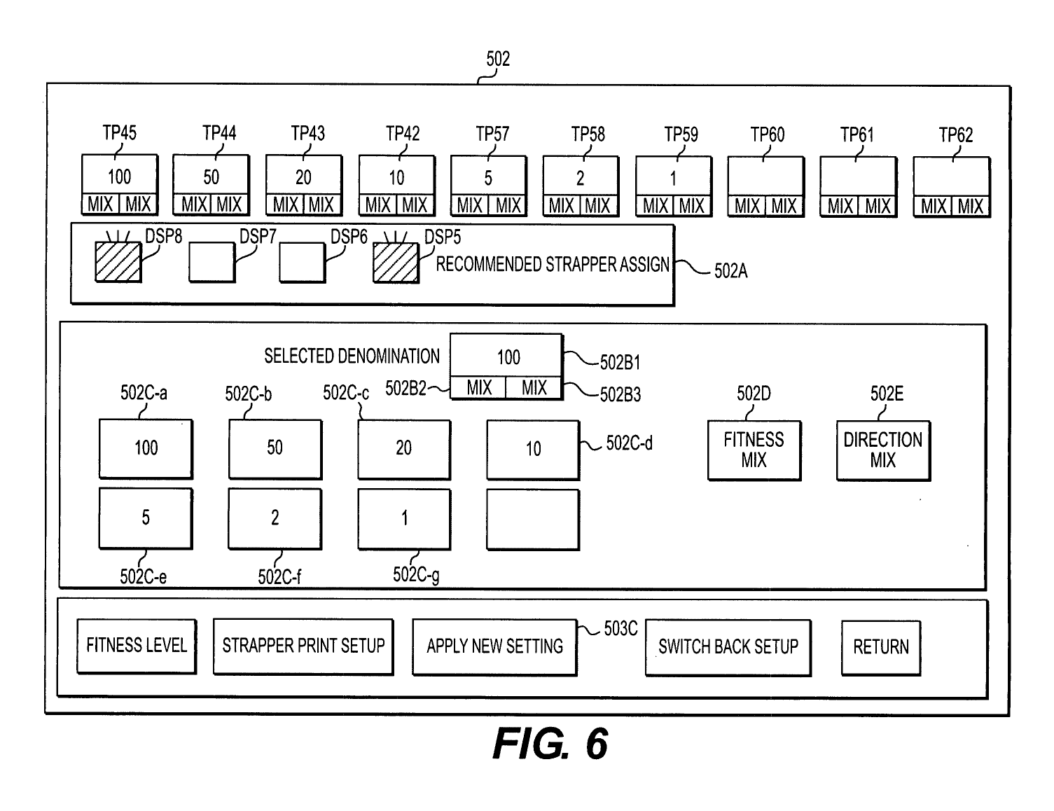

FIG. 6 shows the operation screen by the second embodiment of the present invention, and is an example in the case of notifying an operator of recommendation cassette information based on the conveying carrier operation frequency ratio shown in FIG. 4. Since the composition of the example 2 is the same as the composition of the paper materials sorting apparatus explained in FIGS. 1 to 4 of the first embodiment, the explanation is omitted. Since the portion except RSA indication area 502A of operation screen 502 shown in FIG. 6 is the same as that of the first embodiment shown in FIG. 5, identical codes are attached to identical portions, the explanation is omitted, and a different portion will be explained. Corresponding to touch panels TP42-TP45, four viewing areas DSP1-DSP4 are formed in RSA indication area 502A, and that brightness or foreground color is changed for these four viewing areas DSP 5 to DSP 8 according to a throughput. For example, when there are few meanss of being alike, and following and increasing brightness that make brightness low when there are few throughputs, and a throughput increases, and throughputs, the means of being safe color whose throughput increases, for example using green or blue of it being alike, and following and using red dangerous color is also possible with the existing art.

Next, the example in the case of actually applying is shown. First, cassette assignment of paper-strip wrapping devices 42-45 and storages 57-62 is performed from operation screen 502 in similar to the first embodiment shown in FIG. 5. By the cassette assignment, in similar to first embodiment, 10-denomination note is assigned to touch-panel TP42. 20-denomination note is assigned to touch-panel TP43. 50-denomination note is assigned to touch-panel TP44. 100-denomination note is assigned to the touch-panel TP45. Similarly, 1-denomination note is assigned to the touch-panel TP57. 2-denomination note is assigned to the touch panel. TP58. 5-denomination note is assigned to the touch-panel TP59. The cassette assignment at the time is shown in the drawing.

Next, predetermined dealings operation is performed based on the above-mentioned cassette assignment. Next, balance processing which totals the number of dealings accompanying the dealings business finishing is performed.

Next, in connection with the above-mentioned balance processing end, the balance judging of the throughput according to note denomination within the-unit time about the paper-strip wrapping device of the above-mentioned dealings operation is performed. For example, in a case of bar graphs shown in FIG. 4 indicating throughput of every note denomination per unit time, i.e., conveying carrier operation frequency ratio D given by Equation (1) satisfies Equation (2), it is seen that the throughput of paper-strip wrapping device 42 which processes 10-denomination notes is more than the throughput of paper-strip wrapping device 45 which processes 100-denomination notes exceeding the predetermined set point, and unbalance has occurred.

In the case, it expresses as the color which assigned the foreground color of viewing areas DSP5-DSP8 of RSA indication area 502A according to the throughput of each note denomination. In order to recommend exchange of 10-denomination notes and 100-denomination notes, a recommendation cassette assignment which should blink and should exchange these 10-denomination notes and 100-denomination notes at the time of the next dealings is displayed, and an operator is notified. By the existing art, the various things to carry out are possible for these meanss of presentation and a foreground color, and they take into consideration the established practice of an installation area (country) of installing a paper materials sorting apparatus etc., and are assigned.

An operator refers to these indications, changes assignments of 100-denomination notes and 10-denomination notes in reference to the touch-panel TP42 in similar to first embodiment, and changes assignment of 10-denomination notes and 100-denomination notes in reference to the touch-panel TP46. If necessary, a having mentioned above passage sets up a re-circulation accurate numeral and an un-accurate numeral using a note possible to be re-circulated and re-circulation un-accurate indication touch panel 502D, and can assigned a posture with posture change touch panel 502E. In the illustrated example, re-circulation accurate, disqualified number of sheets (Fitness), and posture breadth in ken show the case where (Mix) is assigned.

As mentioned above, according to the second embodiment, an operator can be notified of the information for the cassette assignment in the next dealings by measuring the cumulative load of a paper-strip wrapping device in similar to first embodiment. If an operator performs cassette assignment based on the advice, although leveling of the load of a processor is attained, and only a specific processor does not become a short life, therefore a maintenance service is performed frequently, it is lost by the need, and efficient employment can be aimed at.

According to the example 2, the effect mentioned above by the very simple means of merely displaying and notifying the processors which should be exchanged can be acquired.

### Third Embodiment

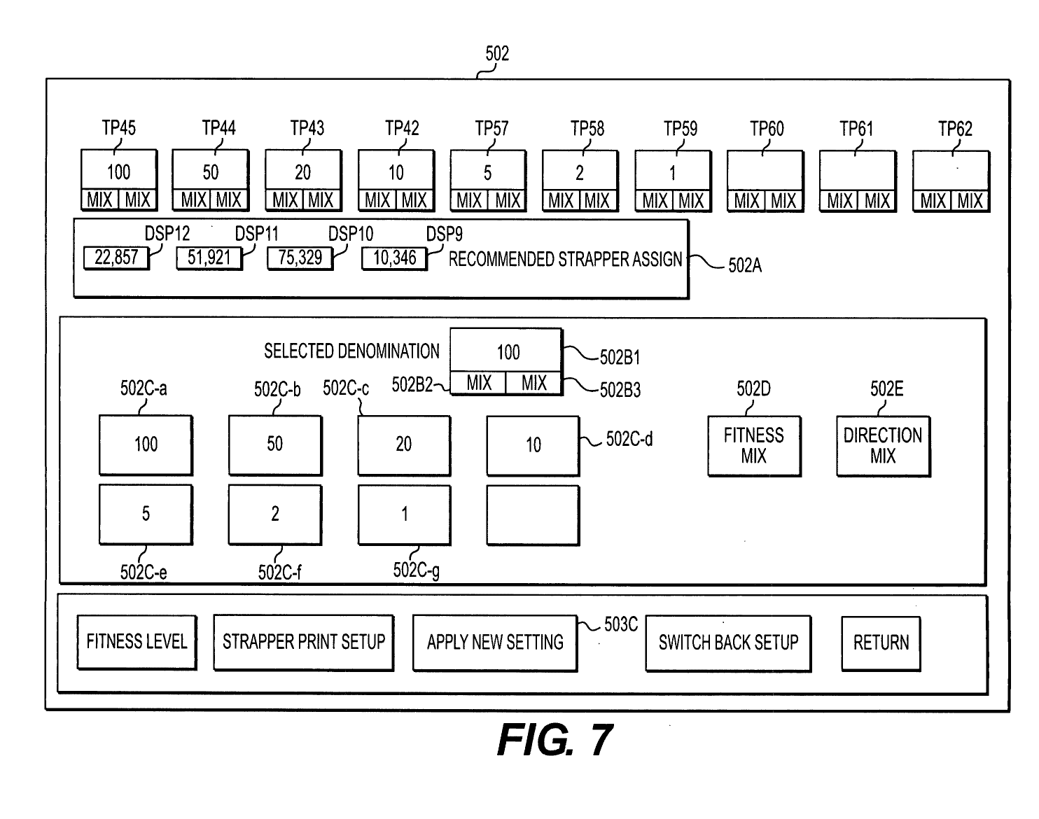

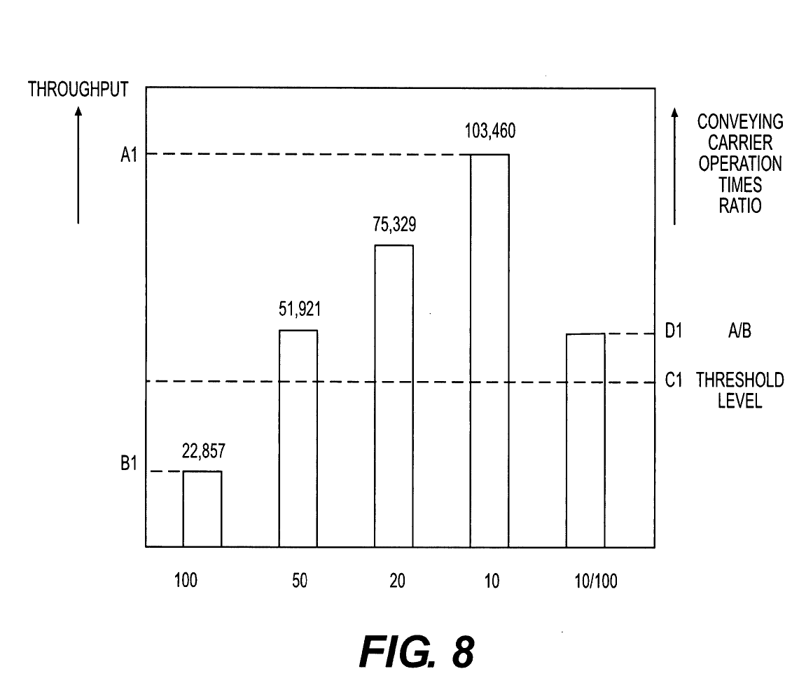

FIG. 7 shows the operation screen by the 3rd embodiment of the present invention, and is an example in the case of notifying an operator of a recommendation cassette based on the processed number of notes discriminated by note denomination and processed number-of-sheets ratio which are shown in FIG. 8. Since the composition of the example 3 is the same as the composition of the paper materials sorting apparatus explained in FIGS. 1-4 of first embodiment, the explanation is omitted. Since the portion except RSA indication area 502A of operation screen 502 shown in FIG. 7 is the same as that of the first embodiment shown in FIG. 5, identical codes are attached to identical portions, the explanation is omitted, and a different portion will be explained. Corresponding to touch panels TP42-TP45, 12 copies of four viewing areas DSP9-DSP are formed in RSA indication area 502A, and processed number of sheets is displayed on these four viewing areas DSP9-DSP12.

Next, the example in the case of actually applying is shown. Cassette assignment of paper-strip wrapping devices 42-45 and storages 57-62 is performed from operation screen 502 in similar to the first embodiment shown in FIG. 5. By the cassette assignment, in similar to the first embodiment, to touch-panel TP42, 10-denomination note is assigned. To touch-panel TP43, 20-denomination note is assigned. To touch-panel TP44, 50-denomination note is assigned. And 100-denomination note is assigned to touch-panel TP45. While one-denomination note is similarly assigned to touch-panel TP57, two-denomination note and five-denomination note are assigned to touch-panel TP59 and touch-panel TP58. The cassette assignment at the time is shown in the drawing.

Next, predetermined dealings operation is performed based on the above-mentioned cassette assignment. Next, balance processing which totals the number of dealings accompanying the dealings business finishing is performed.

Next, in connection with the above-mentioned balance processing end, main controller 500 displays the processed number of sheets of each note denomination on each viewing area corresponding to a note denomination of RSA indication area 502A, and performs the imbalanced judging of the processed number of sheets between paper-strip wrapping devices.

For example, in the case of the example shown in FIG. 8, it can judge similarly by using processed number-of-sheets ratio D1 given with a following equation instead of conveying carrier operation frequency ratio D.
D1=A1/B1 (3)

Here, PS A1: Processed number of sheets of most 10-denomination notes of processed number of sheets

B1: Processed number of sheets of fewest 100-denomination notes of processed number of sheets

Next, processed number-of-sheets ratio D1 for which it asked by the equation (3) is compared with threshold level C1 assigned beforehand. This relation is shown in following Equation (4).
D1>C1 (4)

That is, when processed number-of-sheets ratio D1 given by Equation (3) fills the Equation (4), it turns out that the processed number of sheets of paper-strip wrapping device 42 which processes 10-denomination notes is more than the processed number of sheets of paper-strip wrapping device 45 which processes 100-denomination notes exceeding the predetermined threshold, and unbalance has occurred.

In the case, main controller 500 displays the recommendation cassette which should blink these 10-denomination notes and 100-denomination notes, and should be exchanged at the time of the next dealings, in order to recommend exchange of 10-denomination notes and 100-denomination notes. Although the case where FIG. 8 shows processed number of sheets is shown, processed number of sheets and the number of processing have a proportional relation, and in order that the number of processing may show the created number of bundles, the value which did the division of the processed number of sheets by 100 becomes processed number of sheets.

When an operator refers to the processed number of sheets, for example, it exchanges the processor of 10-denomination notes with much processed number of sheets, and the processor of 100-denomination notes with little processed number of sheets. Ten-denomination notes assigned to touch-panel TP42 in similar to the first embodiment can be changed into 100-denomination notes, and 100-denomination notes assigned to touch-panel TP45 can be changed into 10-denomination notes. If necessary, a having mentioned above passage will assigned the exception of a re-circulation accurate number and a disqualified numeral using re-circulation accurate and disqualified indication change touch panel 502D, and it can assigned a posture with posture change touch panel 502E. In the exception of the number of note possible to be re-circulated, and the number of re-circulation un-accurate tickets, in the illustrated example, the posture shows the case where Mix is assigned.

The operating period for measuring the processed number of sheets can be arbitrarily assigned for every component which constitutes a paper materials sorting apparatus according to the throughput of a paper materials sorting apparatus.

According to the present invention, the paper materials sorting apparatus which can notify an operator of the information for the cassette assignment in the next dealings can be offered by measuring the cumulative load of a processor.

As mentioned above, according to the third embodiment, an operator can be notified of the information for the cassette assignment in the next operation by measuring the cumulative load of a paper-strip wrapping device like the first embodiment or the second embodiment. If an operator performs cassette assignment based on the advice, although leveling of the load of a processor is attained, and only a specific processor does not become a short life, therefore a maintenance service is performed frequently, it is lost by the need, and efficient employment can be aimed at. In the example 3, since the processed number of sheets of a processor is displayed as a cumulative load, leveling of a more precise load is attained.

Further, needless to say, the present invention is not restricted to the embodiment described above but is applicable by variously modifying without departing from the spirit and the scope of the invention.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

What is claimed is:

1. A paper materials sorting apparatus characterized by preparation, comprises:
a note denomination discriminating means for taking out paper material from a feeder supplied collectively, and for discriminating the note denomination of the paper materials; and
a sorting means for sorting the paper materials for every note denomination based on a result of discrimination by the note denomination discriminating means, and to perform discrimination processing of wrapping or storing,
a cassette assignment means for assigning a note denomination to be sorted by the sorting means to the wrapping means or the storage,
the sorting means, comprising:
a counting means which carries out counting of the throughput of the paper materials by which sorting operation is performed with each sorting means based on the cassette assignment means;
a comparison means to measure a throughput between the sorting means based on a result of counting by the counting means;
a comparison result display means which displays a comparison result by the comparison means; and
an operation display means which performs an operation indication by the cassette assignment means, and a comparison result indicated by the comparison result display means,

2. The paper materials sorting apparatus according to claim 1, wherein the cassette assignment means is provided with input means capable of selectively inputting indication of possibility of re-circulation, posture of paper material to be processed in the sorting device in relation to note denomination, and a multiple indication areas provided for every sorting means for display an established state assigned for every sorting means by the setting means, the comparison result display means is provided with a multiple indication areas corresponding to each sorting means

3. The paper materials sorting apparatus according to claim 1, wherein the comparison means displays, among throughputs for the every sorting means in which counting was carried out by the counting means when a ratio of a throughput of a sorting means which shows the maximum over a throughput of a sorting means which shows the minimum exceeds a predetermined threshold, a cassette recommended at the time of the next operation on the operation display.

4. The paper materials sorting apparatus according to claim 1, wherein the comparison means changes, among the throughputs for the every sorting means in which counting was carried out by the counting means when a ratio of a throughput of a sorting means which shows the maximum over a throughput of a sorting means which shows the minimum exceeds a predetermined threshold, a foreground color displayed on the operation display, according to the throughput of each sorting means.

5. The paper materials sorting apparatus according to claim 1, wherein the comparison means, among throughputs for the every sorting means in which counting was carried out by the counting means when a ratio of a throughput of a sorting means which shows the maximum over a throughput of a sorting means which shows the minimum exceeds a predetermined threshold, a throughput for every sorting means on the operation display.
